(19) United States
(12) Patent Application Publication
(10) Pub. No.: US 2012/0050553 A1
(43) Pub. Date: Mar. 1, 2012

(54) ELECTRONIC DEVICE, CAMERA, CAMERA SYSTEM, POSITION MEASUREMENT OPERATION CONTROL PROGRAM AND POSITION MEASUREMENT OPERATION CONTROL METHOD

(75) Inventor: Tomoki NISHIMURA, Matsudo-shi (JP)

(73) Assignee: NIKON CORPORATION, Tokyo (JP)

(21) Appl. No.: 13/288,489

(22) Filed: Nov. 3, 2011

Related U.S. Application Data
(63) Continuation of application No. PCT/JP2010/061043, filed on Jun. 29, 2010.

(30) Foreign Application Priority Data
Jun. 30, 2009 (JP) 2009-155890

(51) Int. Cl. H04N 5/228

(52) U.S. Cl. 348/208.5; 348/208.6; 348/E05.024

(57) ABSTRACT

A camera includes: a photographic lens; an image sensor that captures a subject image; a motion detection unit that detects motion of the camera and outputs a detection signal corresponding to an extent of the motion; a position measurement unit that measures a position assumed by the camera by receiving a radio wave originating from an external source; a blur reducing unit that reduces an extent of blurring in a photographic image attributable to motion of the camera in correspondence to the output value indicated in the detection signal output from the motion detection unit; and a position measurement engagement control unit that disallows engagement of the position measurement unit in operation based upon the output value indicated in the detection signal output from the motion detection unit.

This application is a continuation of International Application No. PCT/JP2010/061043 filed Jun. 29, 2010.

### INCORPORATION BY REFERENCE

The disclosures of the following priority applications are herein incorporated by reference:
Japanese Patent Application No. 2009-155890 filed Jun. 30, 2009 PCT/JP2010/061043 filed Jun. 29, 2010

### BACKGROUND OF THE INVENTION

1. Field of the Invention

The present invention relates to an electronic device, a camera and a camera system each having a function of measuring the position thereof, a position measurement operation control program and a position measurement operation control method.

2. Description of Related Art

There are cameras known in the related art that execute position measurement by using a GPS (global positioning system) unit and recording position measurement information thus obtained as photographing location information. Japanese Laid Open Patent Publication No. 2000-56386 discloses that this type of camera repeatedly executes the position measurement operation over predetermined cycles and updates the position measurement information. If the position measurement operation is executed over excessively short cycles, the battery power in the camera will be depleted quickly. Accordingly, while the camera is set to execute position measurement over short cycles if the photographer is travels a significant distance in a short period of time, longer position measurement operation cycles are set in the camera so as to prevent premature battery depletion if the photographer is staying within a limited range, e.g., if he is staying in an amusement park or the like.

### SUMMARY OF INVENTION

The camera disclosed in patent literature 1 repeatedly executes the position measurement operation over the predetermined cycles even while the camera remains in standby during, for instance, a break or while the photographer remains at a given photographing location over an extended period of time. This gives rise to an issue in that the battery power in the camera will be used up unnecessarily.

According to the 1st aspect of the present invention, a camera comprises: a photographic lens; an image sensor that captures a subject image; a motion detection unit that detects motion of the camera and outputs a detection signal corresponding to an extent of the motion; a position measurement unit that measures a position assumed by the camera by receiving a radio wave originating from an external source; a blur reducing unit that reduces an extent of blurring in a photographic image attributable to motion of the camera in correspondence to the output value indicated in the detection signal output from the motion detection unit; and a position measurement engagement control unit that disallows engagement of the position measurement unit in operation based upon the output value indicated in the detection signal output from the motion detection unit.

According to the 2nd aspect of the present invention, it is preferred that a camera according to the 1st aspect further comprises an electric power mode control unit that controls a switchover from a regular power mode to a power saving mode, or vice versa, in the regular power mode a regular power being provided and in the power saving mode the power supply being restricted; wherein: the position measurement engagement control unit that disallows engagement of the position measurement unit in operation based upon the output value indicated in the detection signal output from the motion detection unit while the electric power mode control unit selects the power saving mode.

According to the 3rd aspect of the present invention, it is preferred that in a camera according to the 2nd aspect, while the power saving mode is selected, the position measurement engagement control unit disallows position measurement by the position measurement unit if the output value indicated in the detection signal output from the motion detection unit is equal to or less than a predetermined value or if the output value indicated in the detection signal output from the motion detection unit is less than a predetermined value.

According to the 4th aspect of the present invention, it is preferred that in a camera according to the 2nd aspect, while the power saving mode is selected, the position measurement engagement control unit engages the position measurement unit in execution of position measurement if the output value indicated in the detection signal output from the motion detection unit is equal to or greater than a predetermined value or if the output value indicated in the detection signal output from the motion detection unit is greater than a predetermined value.

According to the 5th aspect of the present invention, it is preferred that a camera according to the 2nd aspect further comprises: a plurality of operation members; and an operation detection unit that detects an operated state at a specific operation member among the plurality of operation members, wherein: if the operation detection unit detects the specific operation member to have remained unoperated over a specific length of time in the regular power mode, the electric power mode control unit switches to the power saving mode.

According to the 6th aspect of the present invention, a camera according to the 5th aspect may further comprise: a detection unit that detects at least an output of the detection signal to the position measurement engagement control unit and the operated state at the operation member via the operation detection unit while the electronic device is set in the power saving mode.

According to the 7th aspect of the present invention, the position measurement engagement control unit in a camera according to the 1st aspect may disallow position measurement by the position measurement unit in a power OFF state.

According to the 8th aspect of the present invention, the position measurement unit in a camera according to the 1st aspect may be configured as a detachable member.

According to the 9th aspect of the present invention, the blur reducing unit in a camera according to the 1st aspect may reduce the extent of blurring in the photographic image by acting on part of the photographic lens.

According to the 10th aspect of the present invention, the blur reducing unit in a camera according to the 1st aspect may reduce the extent of blurring in the photographic image by acting on the image sensor.

According to the 11th aspect of the present invention, A camera system comprises: a camera body; an interchangeable lens barrel with a photographic lens housed therein, which can be detachably mounted at the camera body; a motion detection unit that detects motion of the camera body and outputs a detection signal corresponding to an extent of the motion; a blur-reducing unit that executes a blur reducing operation to reduce an extent of blurring in a photographic image attributable to the motion of the camera body based upon an output value indicated in the detection signal output from the motion detection unit; a position measurement unit that measures a position assumed by the camera system by receiving a radio wave originating from an external source; and a position measurement engagement control unit that disallows engagement of the position measurement unit in operation based upon an output value indicated in the detection signal output from the motion detection unit, wherein: the motion detection unit is disposed either at the camera body or at the interchangeable lens barrel; and the blur-reducing unit executes a blur reducing operation to reduce the extent of blurring in the photographic image by acting on part of the photographic lens.

According to the 12th aspect of the present invention, it is preferred that in a camera system according to the 11th aspect further comprises: an electric power mode control unit that controls a switchover from a regular power mode to a power saving mode, or vice versa, in the regular power mode a regular power supply being provided and in the power saving mode the power supply being restricted; wherein: the position measurement engagement control unit disallows engagement of the position measurement unit in operation based upon the output value indicated in the detection signal output from the motion detection unit while the electric power mode control unit selects the power saving mode.

According to the 13th aspect of the present invention, a camera system comprises: a camera body; an interchangeable lens barrel with a photographic lens housed therein, which can be detachably mounted at the camera body; a motion detection unit that detects motion of the camera body and outputs a detection signal corresponding to an extent of the motion; a blur-reducing unit that executes a blur reducing operation to reduce an extent of blurring in a photographic image attributable to the motion of the camera body based upon an output value indicated in the detection signal output from the motion detection unit; a position measurement unit that measures a position assumed by the camera system by receiving a radio wave originating from an external source; a position measurement engagement control unit that disallows engagement of the position measurement unit in operation based upon an output value indicated in the detection signal output from the motion detection unit, wherein: the motion detection unit and the blur reducing unit are both disposed at the camera body; and the blur reducing unit reduces the extent of blurring in the photographic image by acting on an image sensor.

According to the 14th aspect of the present invention, it is preferred that a camera system according to the 13th aspect further comprises: an electric power mode control unit that controls a switchover from a regular power mode to a power saving mode, or vice versa, in the regular power mode a regular power being supplied and in the power saving mode the power supply being restricted; wherein: the position measurement engagement control unit disallows engagement of the position measurement unit in operation based upon an output value indicated in the detection signal output from the motion detection unit while the electric power mode control unit selects the power saving mode.

According to the 15th aspect of the present invention, a position measurement operation control program recorded in a computer-readable recording medium, which enables a computer to execute: a motion detection step of detecting motion of a subject device and outputting a detection signal corresponding to an extent of the motion; a position measurement step of measuring a position assumed by the subject device by receiving a radio wave originating from an external source; and a position measurement engagement control step of disallowing execution of the position measurement step based upon an output value indicated in the detection signal.

According to the 16th aspect of the present invention, it is preferred that a position measuring operation control program recorded in a computer-readable medium according to the 15th aspect further comprises: an electric power mode control step of controlling switchover from a regular power mode to a power saving mode, or vice versa, in the regular power mode a regular power being supplied and in the power saving mode the power supply being restricted; wherein: the position measurement engagement control step disallows execution of the position measurement step based upon an output value indicated in the detection signal while the power saving mode is set.

According to the 17th aspect of the present invention, a position measurement operation control method comprises: detecting motion of a subject device and outputting a detection signal corresponding to an extent of the motion; measuring a position assumed by the subject device by receiving a radio wave originating from an external source; and disallowing measurement of the position assumed by the subject device based upon an output value indicated in the detection signal.

According to the 18th aspect of the present invention, it is preferred that a position measurement operation control method according to the 17th aspect further comprises: controlling switchover from a regular power mode to a power saving mode, or vice versa, in the regular power mode a regular power supply being provided and in the power saving mode the power supply being restricted; wherein: disallowing measurement of the position assumed by the subject device based upon an output value indicated in the detection signal while the power saving mode is set.

According to the present invention, the position measurement operation is disallowed in response to a detection signal indicating a state of motion and thus, power consumption necessitated by the position measurement operation can be minimized.

### BRIEF DESCRIPTION OF THE DRAWINGS

FIG. 1 is a block diagram showing the structure adopted in a digital camera achieved in an embodiment of the present invention.

FIG. 2 is a diagram showing the internal structure of the main CPU 108 in FIG. 1.

FIG. 3 is a schematic flowchart of the operations executed in the digital camera.

FIG. 4 is a block diagram showing the structure adopted in a camera system achieved in a variation.

FIG. 5 is a block diagram showing the structure adopted in a camera system achieved in a variation.

FIG. 6 is a block diagram showing the structure adopted in a portable telephone unit achieved in a variation.

FIG. 7 is an illustration of the overall configuration of a system through which a program product can be provided

### DESCRIPTION OF EMBODIMENT

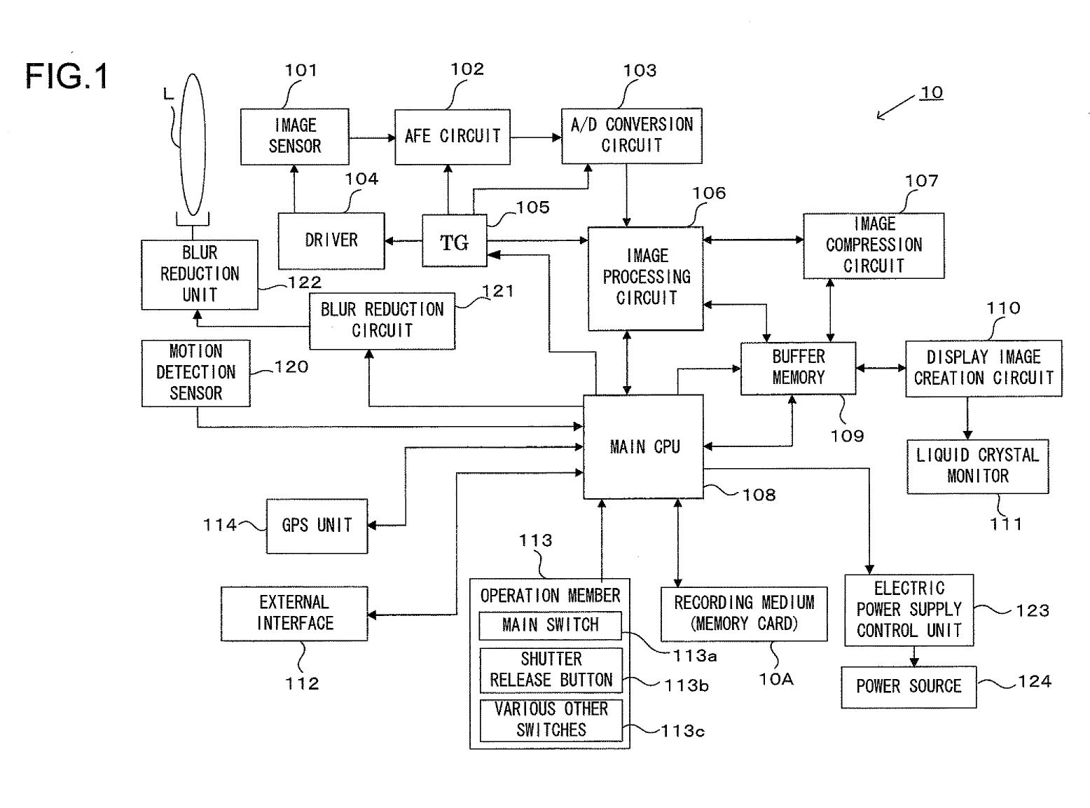

The following is a description of the digital camera achieved in an embodiment of the present invention, given in reference to FIGS. 1 through 3.

(Structure of the Digital Camera)

FIG. 1 is a block diagram showing the essential structure of a digital camera 10. It is to be noted that the digital camera 10 achieved in the embodiment is a camera with an integrated lens, which includes a photographic lens fixed to the camera body as an integrated part thereof. In response to an instruction output from a main CPU 108 in the digital camera structured as shown in FIG. 1, a timing generator (TG) 105 provides a timing signal to a driver 104, an AFE (analog front end) circuit 102, an A/D conversion circuit 103 and an image processing circuit 106. The driver 104 provides a drive signal required at an image sensor 101.

A subject image is formed via a photographic lens L onto an image-capturing surface of the image sensor 101. The image sensor 101 may be, for instance, a CCD image sensor equipped with a plurality of photoelectric conversion elements that correspond to pixels. The image sensor 101 captures the subject image formed on its image-capturing surface and outputs photoelectric conversion signals corresponding to the brightness of the subject image.

The AFE circuit 102 executes analog processing (such as gain control) on the photoelectric conversion signals output from the image sensor 101. The image-capturing signals having undergone the analog processing are converted to digital signals at the A/D conversion circuit 103.

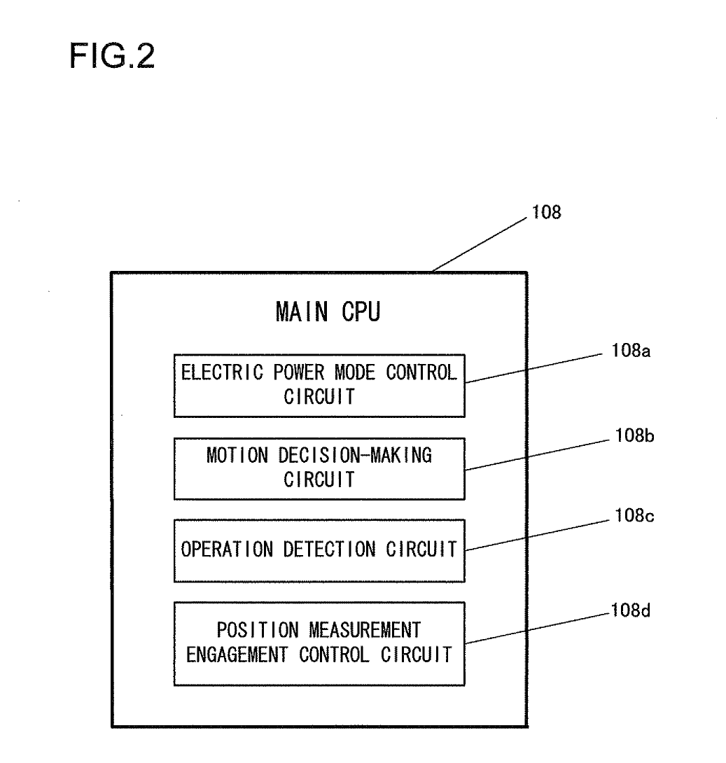

The main CPU 108 detects specific information and executes predetermined arithmetic operations based upon signals input thereto from various blocks and then outputs control signals generated based upon arithmetic operation results to the individual blocks. As shown in FIG. 2, the main CPU 108 includes an electric power mode control circuit 108a, a motion decision-making circuit 108b, an operation detection circuit 108e and a position measurement engagement control circuit 108d.

The electric power mode control circuit 108a controls switchover between a regular power mode and a power saving mode. In the regular power mode, electric power is provided to the various components of the digital camera 10 through a regular power supply. In the power saving mode, electric power is provided only to some of the components of the digital camera 10. The motion decision-making circuit 108b makes a decision based upon a motion detection signal from a motion detection sensor 120 to be described later as to whether the extent of motion detected by the motion detection sensor 120 is equal to or greater than a predetermined value (or whether or not the extent of motion is greater than a predetermined value). The operation detection circuit 108c, which detects an operation signal generated as an operation member 113 is operated, monitors the operation conditions of the operation member 113 in the power saving mode, as described later. In the power saving mode, the position measurement engagement control circuit 108d executes control so as to either allow or disallow position measurement by a GPS unit 114, which is to be described in detail later, based upon the results of the decision made by the motion decision-making circuit 108b.

The image processing circuit 106, which may be an ASIC, executes image processing for digital image signals input thereto from the A/D conversion circuit 103. The image processing executed by the image processing circuit 106 includes, for instance, edge enhancement processing, color temperature adjustment (white balance adjustment) processing and format conversion processing executed on image signals.

An image compression circuit 107 executes image compression processing on the image signals having undergone the image processing executed at the image processing circuit 106 so as to compress them in the JPEG format at a predetermined compression rate. A display image creation circuit 110 creates display data to be used to display a photographic image at a liquid crystal monitor 111. At the liquid crystal monitor 111, a reproduced image corresponding to display data input thereto from the display image creation circuit 110 is displayed. The display image creation circuit 110 also creates data to be used to display messages, menus, icons and the like, as well as the image display data. Information other than an image can thus be displayed at the liquid crystal monitor 111.

A recording medium 10A may be a memory card or the like that can be detachably loaded in the digital camera 10. In response to an instruction issued by the main CPU 108, an image file containing photographic image data and attribute data such as the corresponding photographic information, photographing location position measurement information and the like is recorded into the recording medium 10A. Image files recorded in the recording medium 10A can each be read out in response to an instruction issued by the main CPU 108.

In a buffer memory 109 constituted with a DRAM or the like, data yet to undergo the image processing, data resulting from the image processing, data currently undergoing the image processing and data containing position measurement information which is cyclically obtained are temporarily stored. The buffer memory 109 is also used as a work memory where an image file yet to be recorded into the recording medium 10A or an image file having been read out from the recording medium 10A is stored.

The operation member 113 outputs an operation signal that corresponds to an operation of a switch at the digital camera 10, such as a main switch (i.e., a power switch) 113a, a shutter release button 113b or any of various other switches 113c including a reproduce switch and select/set switches, to the main CPU 108. The select/set switches include a mode selector switch operated to switch from the regular power mode to the power saving mode or vice versa.

The operation detection circuit 108c monitors the operation conditions of specific switches among the various switches, e.g., the main switch 113a and the shutter release button 113b, in the power saving mode. The operation detection circuit 108c detects an operation signal generated as the main switch 113a or the shutter release button 113b is operated. In response to an instruction issued by the main. CPU 108, an external interface 112 exchanges data with an external device (such as a personal computer or a cradle) via a cable (not shown).

In response to an instruction issued by the main CPU 108, the GPS unit 114 receives radio waves transmitted from GPS satellites and outputs a reception signal to the main CPU 108 (position measurement). Based upon the reception signal provided by the GPS unit 114, the main CPU 108 executes a predetermined arithmetic operation to obtain through calculation position measurement information indicating the position (latitude, longitude and altitude) of the digital camera 10. The position measurement information is recorded into the buffer memory 109 where it is to be held on a temporary basis. The position measurement—arithmetic operation—recording sequence described above is repeatedly executed over a specific time interval. It is to be noted that the GPS unit 114 may be a built-in unit included in the camera or it may be an external unit connected to the camera.

The motion detection sensor 120 detects motion of the digital camera 10 and outputs a motion detection signal corresponding to the extent of the motion to the main CPU 108. The motion detection sensor 120 is constituted with an angular speed sensor (gyro sensor) capable of detecting an angular speed, which is disposed at the lens casing or at the camera body. The motion detection sensor 120 detects the acceleration manifesting along the direction perpendicular to the photographic optical axis and outputs to the main CPU 108 a signal indicating the level of the acceleration (acceleration signal) as a motion detection signal. The main CPU 108 outputs the acceleration signal provided thereto to a blur reduction control circuit 121. The blur reduction control circuit 121 provides a drive signal that corresponds to the acceleration signal input thereto, to a blur reduction unit 122. The blur reduction unit 122 reduces the extent of blurring that would manifest in the photographic image by driving the photographic lens L along a direction perpendicular to the photographic optical axis in response to the drive signal.

An electric power supply control unit 123 executes control so as to determine whether or not to supply electric power from a battery 124 to the individual components in response to an instruction issued by the main CPU 108 based upon the electric power supply mode setting. In other words, the main CPU 108 is capable of controlling, via the electric power supply control unit 123, the power supply to the various components from the battery 124. It is to be noted that the battery 124 is preferably a lithium ion storage battery or the like that can be loaded into and unloaded from the digital camera 10 freely.

(Operations of the Digital Camera)

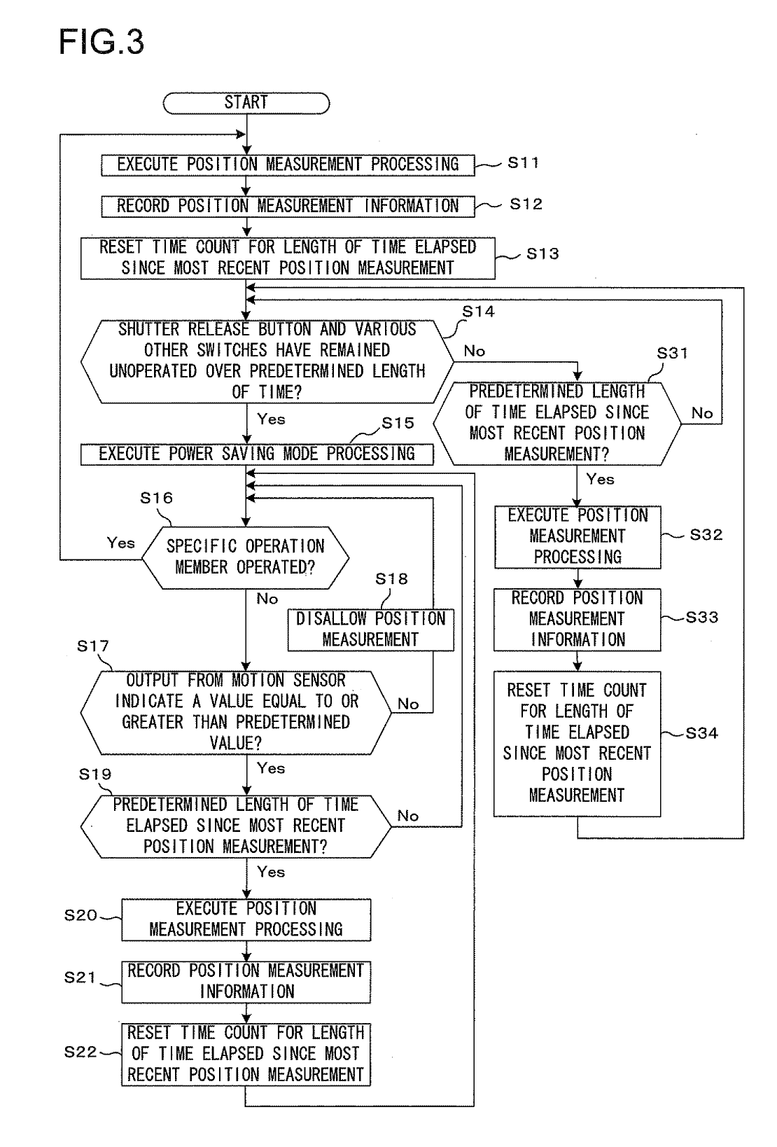

The following is a detailed description of the operations executed in the digital camera 10 under the control of the main CPU 108, given in reference to the flowchart presented in FIG. 3. The control processing in the flowchart presented in FIG. 3 is executed as the main CPU 108 executes a program recorded in a ROM (not shown).

As the main switch 113a at the digital camera 10 is turned on, the main CPU 108 issues an instruction so as to supply power from the battery 124 to the various components shown in FIG. 1. As a result, the various components including the GPS unit 114 and the motion detection sensor 120 start up and the digital camera 10 enters a photographing standby state in the regular power mode.

As shown in FIG. 3, the position measurement engagement control circuit 108d engages the GPS unit 114 in position measurement in step S11. The main CPU 108 obtains position measurement information through calculation executed by using position measurement results provided from the GPS unit 114. In step S12, the main CPU 108 executes control so as to record position measurement information having been obtained through the calculation into the buffer memory 109. In other words, the digital camera 10 is engaged in operation in the regular power mode and in a position measurement mode through steps S11 and S12. In the following step S13, the main CPU 108 resets a time count, counting the length of time having elapsed since the most recent position measurement operation and starts at a time count for the next the position measurement operation.

In step S14, the main CPU 108 checks the conditions of the shutter release button 113b and the various other switches 113c constituting the operation member 113 to determine whether or not they have remained unoperated over a predetermined length of time. Namely, the main CPU 108 detects the conditions at the shutter release button 113b and the various other switches 113c in order to determine whether or not they have remained entirely unoperated over the predetermined length of time. As explained earlier, the operation detection circuit 108c shown in FIG. 2 detects the conditions at the operation member 113 so as to determine whether or not any switch has been operated. It is to be noted that the “predetermined length of time” in reference to which the main CPU 108 detects the conditions of the switches in step S14 may be set to, for instance, “one minute”. While “1 min.” may be set as the initial value for the “predetermined length of time”, the predetermined length of time may be adjusted by the user to “30 sec.” “1 min.”, “5 min.” or “30 min.” selected from a plurality of setting options. If the main CPU 108 determines in step S14 that the predetermined length of time has already elapsed without any of the switches being operated the operation shifts into step S15. In step S15, the electric power mode control circuit 108a executes a switchover from the regular power mode to the power saving mode.

If, on the other hand, the main CPU 108 determines in step S14 that the predetermined length of time has not elapsed, the operation shifts into step S31 to continuously execute the processing in the regular power mode.

Once the electric power mode control circuit 108a switches to the power saving mode setting in step S15, the main CPU 108 outputs an instruction for the power supply control unit 123 so as to control the power supply. As a result, power is supplied only to specific function units and no power is supplied to the other components. The specific function units to which power is supplied include a function unit (the operation detection circuit 108c and the like) that detects operations of the main switch 113a and the shutter release button 113b, a function unit (the motion detection sensor 120, the motion decision-making circuit 108b, the position measurement engagement control circuit 108d and the like) that detects motion and makes a decision as to whether or not the extent of the motion is equal to or greater than a predetermined value, and a function unit (the main CPU 108 and the power supply control unit 123) that controls various operations of the digital camera 1. In addition, once the power saving mode is selected, power is no longer supplied to display-related components such as the display image creation circuit 110 and the liquid crystal monitor 111. Furthermore, in the power saving mode, power is not supplied to photographing-related components such as the external interface 112, the image sensor 101, the AFE circuit 102, the A/D conversion circuit 103, the driver 104, the TG 105 and the image processing circuit 106.

In step S16, the operation detection circuit 108c detects the conditions at members constituting the operation member to determine whether or not a specific operation member such as the main switch 113a or the shutter release switch 113b has been operated. If the operation detection circuit 108c detects an operation signal indicating that the main switch 113a or the shutter release button 113b has been operated, the electric power mode control circuit 108a executes a switchover from the power saving mode to the regular power mode and the operation returns to step S11.

If it is determined in step S16 that the main switch 113a or the shutter release button 113b has not been operated, the operation shifts into step S17. In step S17, the motion decision-making circuit 108b monitors the motion detection signal output from the motion detection sensor 120 and makes a decision as to whether or not the motion detection signal indicates an extent of motion equal to or greater than a predetermined value. If a negative decision is made, the operation shifts into step S18, in which the position measurement engagement control circuit 108d disallows position measurement by the CPS unit 114. Namely, the main CPU 108 issues an instruction for the power supply control unit 123 to halt power supply to the position measurement function unit, which includes the GPS unit 114, and then the operation returns to step S16. In other words, if the motion detection signal indicates a value less than a predetermined value, the main CPU 108 judges that the camera is not currently in use. It is to be noted that the motion decision-making circuit 108a may instead make a decision as to whether or not the motion detection signal indicates a value greater than a predetermined value and judge that the camera is currently left unused if the value indicated by the motion detection signal is equal to or less than a predetermined value.

If an affirmative decision is made in step S17, the main CPU 108 judges that the photographer, holding the camera, is on his way to, for instance, another photographing spot and the camera is thus in a state of use. Accordingly, it does not suspend execution of the position measurement function. In other words, the main CPU 108 continuously supplies power to the position measurement function unit, which includes the GPS unit 114. The operation then proceeds to execute the processing in step S19. In step S19, the main CPU 105 makes a decision as to whether or not a predetermined length of time (e.g., 5 sec.) has elapsed since the most recent position measurement, and if a negative decision is made, the operation returns to step S16. However, if an affirmative decision is made in step S19, the operation proceeds to step S20.

In step S20, position measurement processing is executed by the GPS unit 114 and the main CPU 108 and thus, position measurement information is obtained through calculation. In step S21, the main CPU 108 executes control so as to record position measurement information having been obtained through the calculation into the buffer memory 109. In step S22, the main CPU 108 reset the time count counting the length of time having elapsed since the most recent the position measurement operation and starts a time count for the next position measurement operation, before the operation returns to step S16.

If, on the other hand, it is determined in step S14 that the shutter release button 113b and the various other switches 113c have not remained unoperated over the predetermined length of time yet, the main CPU 108 judges that the camera is continuously engaged in photographing operation. In this case, the regular power mode is sustained and the operation shifts to execute the processing in step S31 and subsequent steps. The processing executed in steps S31 through S34 is identical to that executed in steps S19 through S22, as has been described earlier.

The following advantages are achieved with the digital camera in the embodiment.

(1) Once the electric power mode control circuit 108a selects the power saving mode, the position measurement engagement control circuit 108d cuts off the power supply to the GPS unit 114 and the like if the motion decision-making circuit 108b determines that the value indicated in the motion detection signal output from the motion detection sensor 120 is less than a predetermined value or is equal to or less than a predetermined value. As a result, the position measurement operation by the GPS unit 114 becomes disallowed, and power consumption necessitated by the position measurement operation is thus suspended whenever the camera is not being used.

(2) After the power saving mode is selected by the electric power mode control circuit 108a, the position measurement engagement control circuit 108d engages the GPS unit 114 and the like in execution of position measurement processing if the motion decision-making circuit 108b determines that the value indicated in the motion detection signal output from the motion detection sensor 120 is equal to or greater than a predetermined value or is simply greater than a predetermined value. The position information can be thus obtained immediately whenever the photographer wishes to take a picture, without having to miss any good photo opportunities.

(3) The blur reduction control circuit 121 provides a drive signal, which corresponds to the motion detection signal (acceleration signal) output from the motion detection sensor 120, to the blur reduction unit 122 in order to reduce the extent of blurring in the photographic image. Namely, the motion detection signal output from the motion detection sensor 120 is used both for purposes of making a decision as to whether or not it is necessary to disallow position measurement by the GPS unit 114 and for purposes of reducing the extent of blurring in the digital camera 10. As a result, a compact and lightweight digital camera constituted with fewer components, compared to a camera that includes separate motion detection sensors exclusively used for purposes of making a decision as to whether or not it is necessary to disallow position measurement and for purposes of blur-reduction, can be provided.

Variations of the digital camera achieved in the embodiment are described below.

(1) In the embodiment described above, the switchover from the regular power mode to the power saving mode or vice versa is controlled by the electric power mode control circuit 108a in the main CPU 108. As an alternative, the main CPU 108a may switch to the power saving mode in response to a manual operation of the mode selector switch. In such a case, the operation should forcibly shift into step S15 in the flowchart presented in FIG. 3.

(2) While the digital camera 10 achieved in the embodiment described above executes position measurement by receiving radio waves from artificial satellites, position measurement may instead be executed by using radio waves received via a portable telephone antenna or a PHS antenna. In such a case, the digital camera 10, when set in the power saving mode described earlier, should control the power supply to a circuit that controls communication via the antenna based upon the motion detection signal, in much the same way as it controls the power supply to the GPS unit 114 based upon the motion detection signal.

(3) In the embodiment described above, the value indicated in the motion detection signal output from the motion detection sensor 120 is used both for purposes of making a decision as to whether to disallow or execute position measurement and for blur reduction purposes so as to reduce the extent of blurring in the photographic image by driving the blur reduction unit 122. As an alternative, the digital camera 10 may include separate motion detection sensors each exclusively used for making a decision as to whether or not it is necessary to disallow position measurement or for blur reduction purposes. Furthermore, the digital camera does not need to include the blur reduction unit 122 and may simply include a special motion detection sensor exclusively used for purposes of making a decision as to whether or not it is necessary to disallow position measurement. In either case, an acceleration detection sensor, an angular acceleration detection sensor, a camera attitude longitudinal/lateral orientation detection sensor, an electronic level detector or a sensor capable of detecting an angle change or the like instead of an angular speed sensor (gyro sensor), may be used for purposes of making a decision as to whether to disallow or execute position measurement.

(4) In the embodiment described above, the GPS unit 114 is started up when the main switch 113a is in the ON state and the GPS unit 114 remains inactive if the main switch 113a is in the OFF state. As an alternative, the GPS unit 114 may be started up irrespective of whether the main switch 113a is in the ON state or in the OFF state. In addition, the position measurement engagement control circuit 108d may disallow position measurement by the GPS unit 114 based upon the value indicated in the motion detection signal output from the motion detection sensor 120.

(5) The position measurement engagement control circuit 108d in the embodiment disallows position measurement by the GPS unit 114 based upon the motion detection signal output value relative to a predetermined reference value. As an alternative, the position measurement engagement control circuit 108d may disallow position measurement by the GPS unit 114 depending upon whether or not the motion detection signal output value determined to be less than a predetermined value by the motion decision-making circuit 108b has been sustained over a long period of time. In addition, the position measurement engagement control circuit 108d may disallow position measurement by the GPS unit 114 both based upon the motion detection signal output value ascertained by the motion decision-making circuit 108b and based upon the length of time over which the output value is sustained.

(6) In the embodiment described above, the operation detection circuit 108c detects the conditions of the shutter release button 113b and the various other switches 113c in step S14 to determine whether or not they have remained unoperated over a predetermined length of time. As an alternative, the operation detection circuit 108c may detect the condition of an operation member other than the shutter release button or the various other switches so as to determine whether or not the particular operation member has remained unoperated over a predetermined length of time. In other words, the decision as to whether or not to switch to the power saving mode processing may be made based upon a criterion other than that used in the embodiment described earlier. In addition, while the operation detection circuit 108c in the embodiment described above detects the condition at the main switch 113a and at the shutter release button 113b in step S16 to determine whether or not the main switch 113a or the shutter release button 113b has been operated, an operation signal corresponding to an operation member other than either of those may instead be detected. Namely, the decision as to whether or not to switch to the regular power mode may be made based upon a criterion other than that used in the embodiment.

(7) While the present invention is adopted in a digital camera in the embodiment described above, the present invention is not limited to this example and it may be adopted in a camera that uses silver halide film.

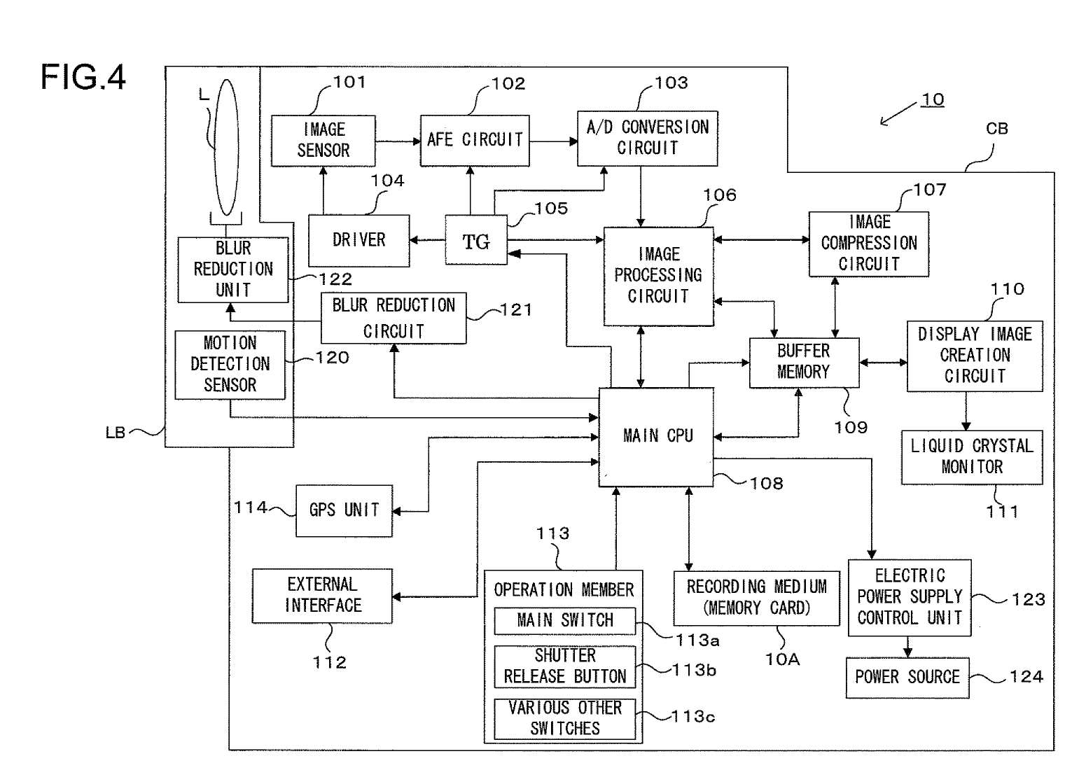

(8) The present invention may be also adopted in a camera system that includes the photographic lens L shown in FIG. 1, which is constituted as an interchangeable lens, and components other than the photographic lens L provided in the camera body. FIG. 4 provides a block diagram showing the structure of such a camera system. It is to be noted that components in the block diagram in FIG. 4 that are identical to components of the digital camera 10 shown in FIG. 1, are assigned with the same reference numerals. An interchangeable lens barrel LB with the photographic lens L housed therein is detachably mounted at a camera body CB in this camera system. The motion detection sensor 120 and the blur reduction unit 122 are disposed inside the interchangeable lens barrel LB. The blur reduction unit 122 reduces the extent of blurring in the photographic image by driving the photographic lens L along a direction perpendicular to the photographic optical axis. It is to be noted that the camera body CB exchanges various signals with the motion detection sensor 120 and the blur reduction unit 122 via an electric contact point (not shown) present at the lens mount. In an alternative configuration, the motion detection sensor 120 may be disposed inside the camera body CB.

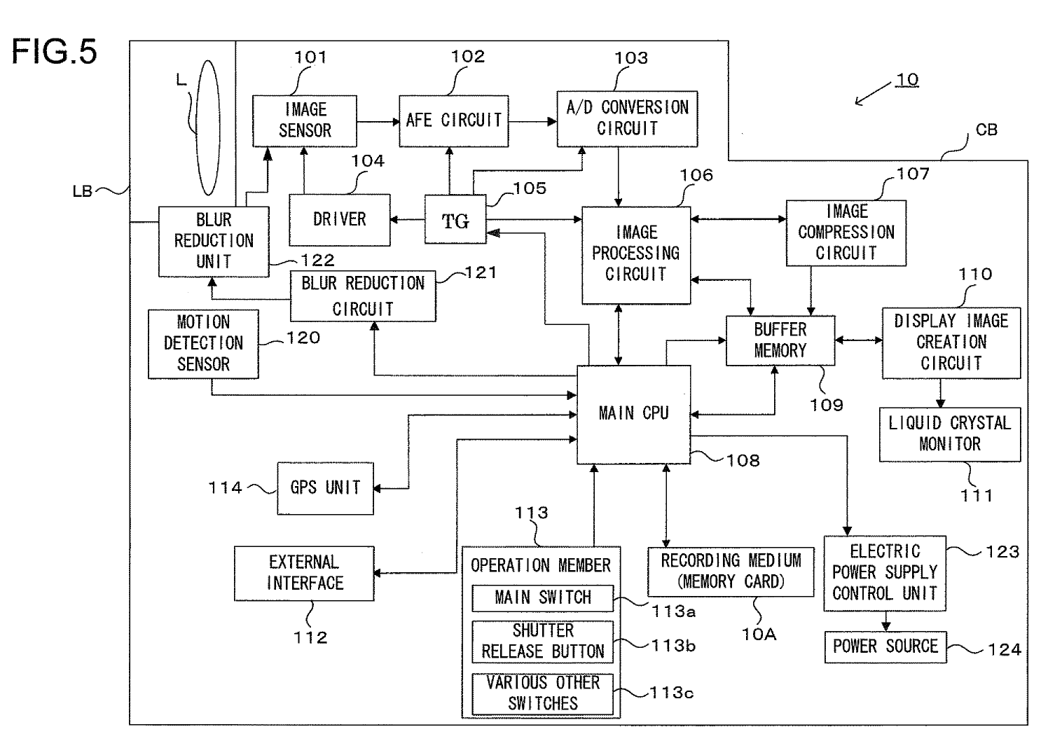

As a further alternative, the present invention may be adopted in a camera system assuming the structure shown in the block diagram in FIG. 5. It is to be noted that components in the block diagram in FIG. 5 that are identical to components of the digital camera 10 shown in FIG. 1, are assigned with the same reference numerals. An interchangeable lens barrel LB with the photographic lens L housed therein is detachably mounted at the camera body CB in this camera system. The motion detection sensor 120 and the blur reduction unit 122 are disposed at the camera body CB. The blur reduction unit 122 reduces the extent of blurring in the photographic image by driving the image sensor 101 along a direction perpendicular to the optical axis.

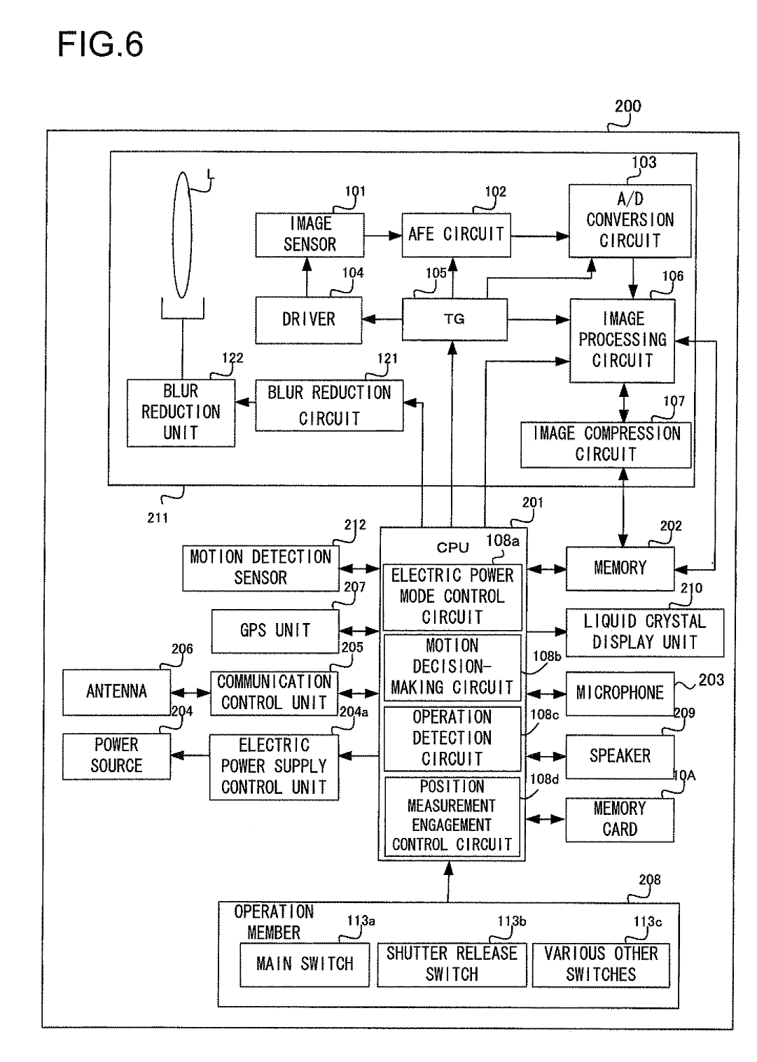

(9) The present invention may be adopted in an electronic device other than a digital camera, such as a portable telephone, a display device, a personal computer or a music playback device. A variation achieved by adopting the present invention in an alternative electronic device constituted with a portable telephone is now described. FIG. 6 is a block diagram showing the essential structure of a portable telephone 200. At the portable telephone 200, comprising a CPU 201, a memory 202, a microphone 203, a power source, an electric power supply control unit 204a, a communication control unit (circuit) 205, an antenna 206, a GPS unit 207, an operation member 208, a speaker 209, a liquid crystal display unit 210, a camera unit 211, a motion detection sensor 212, a detachable memory card 10a is loaded.

The CPU 201 acting as a controller executes predetermined arithmetic operations by using signals input thereto from various units constituting the portable telephone 200 based upon a control program. The CPU 201 individually controls telephone operations and camera operations by outputting control signals for the various units constituting the portable telephone 200 based upon the arithmetic operation results. It is to be noted that the control program is stored in a nonvolatile memory (not shown) within the CPU 201. This control program may be stored in the nonvolatile memory in advance prior to product shipment or it may be stored into the nonvolatile memory after product shipment. The control program, in the latter case, may be downloaded via, for instance, a network and the downloaded control program may then be stored into the nonvolatile memory. As does the main CPU 108 in the embodiment, the CPU 201 includes the electric power mode control circuit 108a, the motion decision-making circuit 108b, the operation detection circuit 108c and the position measurement engagement control circuit 108d.

The memory 202 is used as a work memory by the CPU 201. In response to a command issued by the CPU 201, data such as image data output from the camera unit 211 can be written into and saved in the memory card 10A constituted with a nonvolatile memory or data saved in the memory card 10A can be read out.

The microphone 203 converts sound collected thereat to an electric signal and outputs the electric signal to the CPU 201 as an audio signal. During a phone conversation, the audio signal is provided to the communication control unit 205. Via the speaker 209, the sound expressed by the audio signal output from the CPU 201 is reproduced. The operation member 208, which includes dialing buttons at the telephone and the like, outputs an operation signal corresponding to a depressed button to the CPU 201. It is to be noted that the operation member 208 further includes the main switch 113a, the shutter release button 113b and the various other switches 113c having been described in reference to the embodiment.

As does the GPS unit 114 included in the digital camera 10 in the embodiment, the GPS unit 207 receives a signal from a GPS satellite and outputs a reception signal to the CPU 201. The CPU 201 adopts a structure that enables it to obtain through arithmetic operation position measurement information by using the reception signal provided by the GPS unit 207. The communication control unit 205, which includes a wireless transmission/reception circuit, engages in communication with another telephone via a base station (not shown) in response to a command issued by the CPU 201. The communication control unit 205 adopts a structure that enables it to transmit/receive image data expressing an image photographed via the camera unit 211, as well as the audio significant of the telephone conversation. The antenna 206 is used by the communication control unit 205 as a transmission/reception antenna. It is to be noted that the portable telephone 200 may execute position measurement by using radio waves received via the antenna 206 instead of radio waves from artificial satellites received via the GPS unit 207. In such a case, the portable telephone 200 in a power saving mode, to be detailed later, should control the power supply to the communication control unit 205 based upon the motion detection signal in much the same way as it controls the power supply to the GPS unit 207 based upon a motion detection signal.

The power source 204, which may be constituted with, for instance, a detachable battery pack and a DC/DC conversion circuit, provides power needed at various components within the portable telephone 200. The CPU 201 controls the power supply to the individual components from the battery 204 via an electric power supply control circuit 204a. At the liquid crystal display unit 210, an image, text information and the like are brought up on display in response to a command issued by the CPU 201. The operation conditions of the portable telephone 200, an operation menu, the contents of an e-mail sent from or received at the portable telephone, or the like is displayed in the form of the text information. Via the speaker 209, the sound expressed by the audio signal output from the CPU 201 is reproduced. As does the motion detection sensor 120 in the embodiment, the motion detection sensor 212 detects motion of the portable telephone 200 and outputs a motion detection signal corresponding to the extent of the detected motion to the CPU 201. As does the digital camera 10 in the embodiment, the camera unit 211 includes a photographic lens L, an image sensor 101, an AFE circuit 102, an A/D conversion circuit 103, a driver 104, a timing generator (TG) 105, an image processing circuit 106, an image compression circuit 107, a blur reduction control circuit 121 and a blur reduction unit 122. As does the blur reduction unit in the digital camera 10 achieved in the embodiment, the blur reduction unit 122 reduces the extent of blurring in the photographic image by driving the photographic lens L along a direction perpendicular to the photographic optical axis. It is to be noted that the blur reduction unit 122 may instead reduce the extent of blurring in the photographic image by driving the image sensor 101 along a direction perpendicular to the optical axis.

The CPU 201 in the portable telephone 200 structured as described above executes the processing in the flowchart presented in FIG. 3 to achieve switchover control from the regular power mode to the power saving mode or vice versa, so as to engage the portable telephone 200 in operation either in the regular power mode or in the power saving mode. In other words, once the electric power mode control circuit 108a selects the power saving mode, the position measurement engagement control circuit 108d cuts off the power supply to the GPS unit 207 and the like if the motion decision-making circuit 108b determines that the value indicated in the motion detection signal output from the motion detection sensor 212 is less than a predetermined value. As a result, the position measurement operation by the GPS unit 207 becomes disallowed, thereby suspending the power consumption necessitated by a position measurement operation whenever the portable telephone 200 is not in use, as in the digital camera 10 achieved in the embodiment. In addition, even after the electric power mode control circuit 108a selects the power saving mode, the position measurement engagement control circuit 108d engages the GPS unit 207 and the like in position measurement processing if the motion decision-making circuit 108b determines that the value indicated by the motion detection signal output from the motion detection sensor 212 is equal to or greater than a predetermined value. It is to be noted that the position measurement engagement control circuit 108d may instead cut off the power supply to the GAS unit 207 and the like if the motion decision-making circuit 108b determines that the value indicated in the motion detection signal is equal to or less than a predetermined value. In such a case, if the motion decision-making circuit 108b determines that the motion detection signal indicates a value greater than a predetermined value, the position measurement engagement control circuit 108b should engage the GPS unit 207 and the like in execution of position measurement processing.

Some of the functions of the main CPU 108 in the embodiment or the CPU 201 in the variation described above, such as the functions fulfilled by the electric power mode control circuit 108a, the motion decision-making circuit 108b, the operation detection circuit 108e and the position measurement engagement control circuit 108d, may be achieved in a computer. In such a case, a program that will enable a computer system to fulfill the control functions, recorded into a computer-readable recording medium, may be read into the computer system and the computer system may then execute the control program so as to fulfill the control functions. It is to be noted that the term “computer system” in this context refers to a system that includes an OS (operating system) and hardware constituting the peripheral devices. In addition, the term “computer-readable recording medium” in this context refers to a portable recording medium such as a flexible disk, a magneto-optical disk, an optical disk or a memory card, a storage device such as a hard disk built into the computer system, or the like. Furthermore, the term “computer-readable recording medium” may also refer to a medium capable of briefly and dynamically holding the program, e.g., a communication line through which the program is transmitted via a network such as the Internet or via a communication network such as a telephone network. The term “computer-readable recording medium” may further refer to a medium capable of holding the program over a predetermined length of time, e.g., a volatile memory installed in a server enabling the communication or installed in a client computer system. Moreover, the program mentioned above may enable the computer system to fulfill some of the functions described earlier, or it may enable the computer system to fulfill the functions in conjunction with an existing program recorded in the computer system.

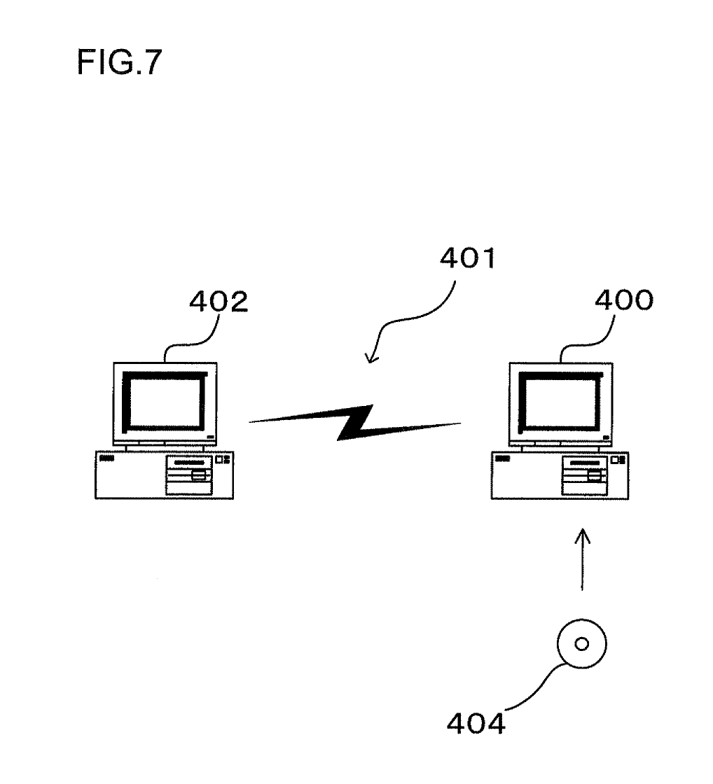

In addition, when the present invention is adopted in a personal computer or the like, the control program mentioned above may be provided in a recording medium such as a CD-ROM or as a data signal transmitted through the Internet or the like. FIG. 7 shows how the program may be provided. A personal computer 400 receives the program provided via a CD-ROM 404. The personal computer 400 is also capable of establishing a connection with a communication line 401. A computer 402 is a server computer that provides the program stored in a recording medium such as a hard disk. The communication line 401 may be a communication network such as the Internet, a personal computer communication network or it may be a dedicated communication line. The computer 402 transmits the program read out from the hard disk, to the personal computer 400 via the communication line 401. Namely, the program may be transmitted as a data signal on a carrier wave via the communication line 401. In short, the program may be distributed as a computer-readable computer program product adopting any of various modes, including a recording medium and a carrier wave.

It is to be noted that the embodiment described above simply represents an example and the present invention is in no way limited to this example as long as the functions characterizing the present invention remain intact. In addition, any mode of implementation conceivable employing the technical teachings of the present invention will be within the scope of the present invention.

What is claimed is:

1. A camera, comprising:
a photographic lens;
an image sensor that captures a subject image;
a motion detection unit that detects motion of the camera and outputs a detection signal corresponding to an extent of the motion;
a position measurement unit that measures a position assumed by the camera by receiving a radio wave originating from an external source;
a blur reducing unit that reduces an extent of blurring in a photographic image attributable to motion of the camera in correspondence to the output value indicated in the detection signal output from the motion detection unit; and
a position measurement engagement control unit that disallows engagement of the position measurement unit in operation based upon the output value indicated in the detection signal output from the motion detection unit.

2. A camera according to claim 1 further comprising
an electric power mode control unit that controls a switchover from a regular power mode to a power saving mode, or vice versa, in the regular power mode a regular power being provided and in the power saving mode the power supply being restricted; wherein:
the position measurement engagement control unit that disallows engagement of the position measurement unit in operation based upon the output value indicated in the detection signal output from the motion detection unit while the electric power mode control unit selects the power saving mode.

3. A camera according to claim 2, wherein:
while the power saving mode is selected, the position measurement engagement control unit disallows position measurement by the position measurement unit if the output value indicated in the detection signal output from the motion detection unit is equal to or less than a predetermined value or if the output value indicated in the detection signal output from the motion detection unit is less than a predetermined value.

4. A camera according to claim 2, wherein:
while the power saving mode is selected, the position measurement engagement control unit engages the position measurement unit in execution of position measurement if the output value indicated in the detection signal output from the motion detection unit is equal to or greater than a predetermined value or if the output value indicated in the detection signal output from the motion detection unit is greater than a predetermined value.

5. A camera according to claim 2, further comprising:
a plurality of operation members; and
an operation detection unit that detects an operated state at a specific operation member among the plurality of operation members, wherein:
if the operation detection unit detects the specific operation member to have remained unoperated over a specific length of time in the regular power mode, the electric power mode control unit switches to the power saving mode.

6. A camera according to claim 5, further comprising:
a detection unit that detects at least an output of the detection signal to the position measurement engagement control unit and the operated state at the operation member via the operation detection unit while the electronic device is set in the power saving mode.

7. A camera according to claim 1, wherein:
the position measurement engagement control unit disallows position measurement by the position measurement unit in a power OFF state.

8. A camera according to claim 1, wherein:
the position measurement unit is configured as a detachable member.

9. A camera according to claim 1, wherein:
the blur reducing unit reduces the extent of blurring in the photographic image by acting on part of the photographic lens.

10. A camera according to claim 1, wherein:
the blur reducing unit reduces the extent of blurring in the photographic image by acting on the image sensor.

11. A camera system comprising:
a camera body;
an interchangeable lens barrel with a photographic lens housed therein, which can be detachably mounted at the camera body;
a motion detection unit that detects motion of the camera body and outputs a detection signal corresponding to an extent of the motion;
a blur-reducing unit that executes a blur reducing operation to reduce an extent of blurring in a photographic image attributable to the motion of the camera body based upon an output value indicated in the detection signal output from the motion detection unit;
a position measurement unit that measures a position assumed by the camera system by receiving a radio wave originating from an external source; and
a position measurement engagement control unit that disallows engagement of the position measurement unit in operation based upon an output value indicated in the detection signal output from the motion detection unit, wherein:
the motion detection unit is disposed either at the camera body or at the interchangeable lens barrel; and
the blur-reducing unit executes a blur reducing operation to reduce the extent of blurring in the photographic image by acting on part of the photographic lens.

12. A camera system according to claim 11, further comprising:
an electric power mode control unit that controls a switchover from a regular power mode to a power saving mode, or vice versa, in the regular power mode a regular power supply being provided and in the power saving mode the power supply being restricted; wherein:
the position measurement engagement control unit disallows engagement of the position measurement unit in operation based upon the output value indicated in the detection signal output from the motion detection unit while the electric power mode control unit selects the power saving mode.

13. A camera system comprising:
a camera body;
an interchangeable lens barrel with a photographic lens housed therein, which can be detachably mounted at the camera body;
a motion detection unit that detects motion of the camera body and outputs a detection signal corresponding to an extent of the motion;
a blur-reducing unit that executes a blur reducing operation to reduce an extent of blurring in a photographic image attributable to the motion of the camera body based upon an output value indicated in the detection signal output from the motion detection unit;
a position measurement unit that measures a position assumed by the camera system by receiving a radio wave originating from an external source;
a position measurement engagement control unit that disallows engagement of the position measurement unit in operation based upon an output value indicated in the detection signal output from the motion detection unit, wherein:
the motion detection unit and the blur reducing unit are both disposed at the camera body; and
the blur reducing unit reduces the extent of blurring in the photographic image by acting on an image sensor.

14. A camera system according to claim 13 further comprising:
an electric power mode control unit that controls a switchover from a regular power mode to a power saving mode, or vice versa, in the regular power mode a regular power being supplied and in the power saving mode the power supply being restricted; wherein:
the position measurement engagement control unit disallows engagement of the position measurement unit in operation based upon an output value indicated in the detection signal output from the motion detection unit while the electric power mode control unit selects the power saving mode.

15. A position measurement operation control program recorded in a computer-readable recording medium, which enables a computer to execute:
a motion detection step of detecting motion of a subject device and outputting a detection signal corresponding to an extent of the motion;
a position measurement step of measuring a position assumed by the subject device by receiving a radio wave originating from an external source; and
a position measurement engagement control step of disallowing execution of the position measurement step based upon an output value indicated in the detection signal.

16. A position measuring operation control program recorded in a computer-readable medium according to claim 15, further comprising:
an electric power mode control step of controlling switchover from a regular power mode to a power saving mode, or vice versa, in the regular power mode a regular power being supplied and in the power saving mode the power supply being restricted; wherein:
the position measurement engagement control step disallows execution of the position measurement step based upon an output value indicated in the detection signal while the power saving mode is set.

17. A position measurement operation control method comprising:
detecting motion of a subject device and outputting a detection signal corresponding to an extent of the motion;
measuring a position assumed by the subject device by receiving a radio wave originating from an external source; and
disallowing measurement of the position assumed by the subject device based upon an output value indicated in the detection signal.

18. A position measurement operation control method according to claim 17, further comprising:
controlling switchover from a regular power mode to a power saving mode, or vice versa, in the regular power mode a regular power supply being provided and in the power saving mode the power supply being restricted; wherein:
disallowing measurement of the position assumed by the subject device based upon an output value indicated in the detection signal while the power saving mode is set.
